(19) United States
(12) Patent Application Publication
(10) Pub. No.: US 2009/0056078 A1
(43) Pub. Date: Mar. 5, 2009

(54) Floating hinge assembly

(75) Inventor: David K. Njaastad, Palatine, IL (US)

Correspondence Address: PYLE & PIONTEK LLC, 221 N. LASALLE STREET, SUITE 2036, CHICAGO, IL, 60601, US

(73) Assignee: IMI Cornelius Inc., Glendale Heights, IL (US)

(21) Appl. No.: 12/231,180

(22) Filed: Aug. 29, 2008

Related U.S. Application Data
(60) Provisional application No. 60/966,901, filed on Aug. 30, 2007.

(51) Int. Cl. E05D 3/06; E05D 3/00

(52) U.S. Cl. 16/366; 16/382

(57) ABSTRACT

A floating hinge assembly is characterized by a mounting base for attachment to a cabinet of a machine along a side of an opening to the cabinet, two door bases for attachment to a door of the machine along a side of the door, and a pivot arm and two idler arms rotatably connected to and between the mounting base and door bases. The pivot arm and idler arms control movement of the door bases as the door is opened, such that as the door is opened the side of the door along which the door bases are attached moves both away from and sideways relative to the cabinet

This application claims benefit of provisional patent application Ser. No. 60/966,901, filed Aug. 30, 2007.

### FIELD OF THE INVENTION

The present invention relates to hinges, and in particular to a floating hinge assembly.

### BACKGROUND OF THE INVENTION

Hinges are used to connect two objects in a manner allowing relative rotation between the objects, normally about a single fixed axis. A floating hinge, on the other hand, is a hinge that is able to behave as a normal hinge, but is also able to allow one of the objects connected by the hinge to move or “float” away from the other object connected to the hinge. In effect, a floating hinge provides two parallel axes of rotation, such that in operation of the floating hinge there is relative movement of the axes toward and away from each other and/or there is relative movement of the axes about each other. For example, a floating hinge may be used in a flatbed scanner designed to scan thick objects such as books. If a sheet of paper is placed on the glass and the cover is lowered over it, the cover, glass and paper will be very dose together. On the other hand, if a thick book is placed on the glass, an ordinary hinge would leave the cover at an angle to the glass. A floating hinge, however, can raise the hinged edge of the cover to the level of the book, so that the cover not only remains parallel to the glass, but also is raised above it with the book between the cover and glass. Another example of use of floating hinges is in two-plate electric cooking grills, as they allow for even heating of both sides of a thick piece of foodstuff without crushing it.

Beverage dispensing machines, such as soft drink and coffee dispensers, often have front doors that can be opened to provide access to the interiors of the machines for such purposes as maintenance and replenishment of beverage ingredients used in the preparation and service of beverages to customers. Counter space to accommodate such machines in commercial establishments is usually at a premium, since the less counter space a machine is required to occupy, the greater the remaining counter space that is available for use in displaying and selling other products. To maximize usage of available counter space, it can be desirable to place a beverage machine in a recessed area or immediately alongside other machines or displays. However, a problem encountered in such situations is maintaining an ability to open a front door of the beverage machine, which upon opening normally swings out beyond a side edge of a cabinet of the machine and, therefore, cannot be blocked by an enclosure in which the beverage machine is placed or by an adjacent object placed immediately alongside the machine. It would therefore be desirable to provide a floating hinge assembly for such beverage machines, which accommodates opening of a front door of the machine without need for the door to move to beyond a side edge of the machine and which, at the same time, accommodates movement of the hinged edge of the door away from a front face of a cabinet of a machine to which the door is connected.

### OBJECT OF THE INVENTION

A primary object of the present invention is to provide a floating hinge assembly for mounting a door on a cabinet, which when the door is opened both moves a hinged side of the door generally sideways relative to the cabinet in a direction such that the hinged side does not extend beyond an adjacent side of the cabinet, and at the same time moves the hinged side of the door away from the front of the cabinet

### SUMMARY OF THE INVENTION

In accordance with the present invention, there is provided a floating hinge assembly comprising a mounting base for attachment to a cabinet; a door base for attachment to a door generally along a side of the door; a pivot arm extending between and rotatably connected to each of the mounting base and the door base; and an idler arm extending between and rotatably connected to each of the mounting base and the door base. The pivot arm and the idler arm control movement of the door base relative to the mounting base, such that when a door is mounted on a cabinet by the floating hinge assembly, as the door is moved away from the cabinet, a side of the door along which the door base is attached moves both away from and sideways relative to the cabinet.

In a disclosed embodiment, the door base can comprises two door bases and two idler arms, each idler arm extending between and rotatably connected to the mounting base and an associated one of the door bases. Means may be provided on the mounting base for supporting a ribbon cable and accommodating passage of the ribbon cable past the mounting base. Each the idler arm is elongate and rotatably attached toward one of its ends to a first point on an associated one of the door bases, and toward an opposite end to a first point on the mounting base, for rotation of the door bases on the idler arms about a first axis passing through the door base first points and for rotation of the idler arms on the mounting base about a second axis passing through the mounting base first points. The pivot arm is rotatably attached toward one of its ends to a second point on each of the door bases and is rotatably attached toward an opposite end to second points on the mounting base, for rotation of the door bases on the pivot arm about a third axis passing through the door base second points and for rotation of the pivot arm on the mounting base about a fourth axis passing through the mounting base second points. The arrangement also mounts the door bases for movement of the door base first points in an arc about the mounting base first points and for movement of the door base second points in an arc about the mounting base second points.

A floating hinge assembly, may also comprise a mounting base; a door base; first means extending between and rotatably coupled to each of the door base and the mounting base for mounting the door base for rotation about a first axis extending through a first point on the door base and for rotation about a second axis extending through a second point on the mounting base with the door base first point moving in an arc around the mounting base second point; and second means extending between and rotatably coupled to each of the door base and the mounting base for mounting the door base for rotation about a third axis extending through a third point on the door base and for rotation about a fourth axis extending through a fourth point on the mounting base with the door base third point moving in an arc around the mounting base fourth point. The first, second, third and fourth axes are parallel, and the first and second mounting means constrain the door base for movement relative to the mounting base such that there is simultaneous rotation of the door base about the first and third axes and rotation of the door base first and third axes in an arc about the mounting base second and fourth axes, respectively.

In the disclosed embodiment of floating hinge assembly, the door base comprises a pair of the door bases, the first means comprises a pair of the first means each extending between and rotatably coupled to an associated one of the door bases and the mounting base for mounting each door base for rotation about the first axis and for rotation of the first axis in an arc around the second axis, and the second means extends between and is rotatably coupled to each of the door bases and the mounting base for mounting each door base for rotation about the third axis and for rotation of the third axis in a arc around the fourth axis.

The invention also contemplates a method of hinging a door to a cabinet, which method comprises the steps of attaching a mounting base to the cabinet; attaching a door base to a door; rotatably coupling the door base to the mounting base for rotation of the door base about a first axis extending through a first point on the door base and about a second axis extending through a second point on the mounting base, and for rotation of the door base first axis in an arc around the mounting base second axis; and rotatably coupling the door base to the mounting base for rotation of the door base about a third axis extending through a third point on the door base and about a fourth axis extending through a fourth point on the mounting base, and for rotation of the door base third axis in an arc around the mounting base fourth axis.

In performance of the method, the rotatably coupling steps are advantageously performed such that the first, second, third and fourth axes are parallel. Also, the rotatably coupling steps advantageously are performed such that the door base is constrained for movement relative to the mounting base such that there is simultaneous rotation of the door base about the first and third axes, rotation of the first axis in an arc about the second axis and rotation of the third axis in an arc about the fourth axis. The step of providing on the mounting base a support for a ribbon cable may be included.

### BRIEF DESCRIPTION OF THE DRAWINGS

FIG. 1 is an exploded assembly view of a floating hinge assembly configured according to the teachings of the present invention;

FIGS. 2 and 3 are perspective views of the floating hinge assembly;

FIG. 4 is a top plan view of the hinge assembly;

FIG. 5 is a side elevation view of the hinge assembly;

FIG. 6 is a bottom plan view of the hinge assembly;

FIG. 7 is a cross-sectional side elevation view of the hinge assembly, taken substantially along the lines 7-7 of FIG. 5;

FIG. 8 is a perspective view showing a pair of floating hinge assemblies as used to mount a door over an opening on a front of a cabinet;

FIGS. 9A-9E show sequential positions in the movement of the door, as mounted on the cabinet by the pair of floating hinge assemblies, when the door is moved between closed and open positions;

FIG. 10 is similar to FIG. 1, and additionally shows a manner in which the floating hinge assembly accommodates passage of a ribbon cable that can extend between a control panel on a front of a door of a beverage dispenser and beverage dispensing components in an interior of a cabinet of the dispenser; and

FIG. 11 is similar to FIG. 4 and shows the axes of rotation of certain components of the floating hinge assembly.

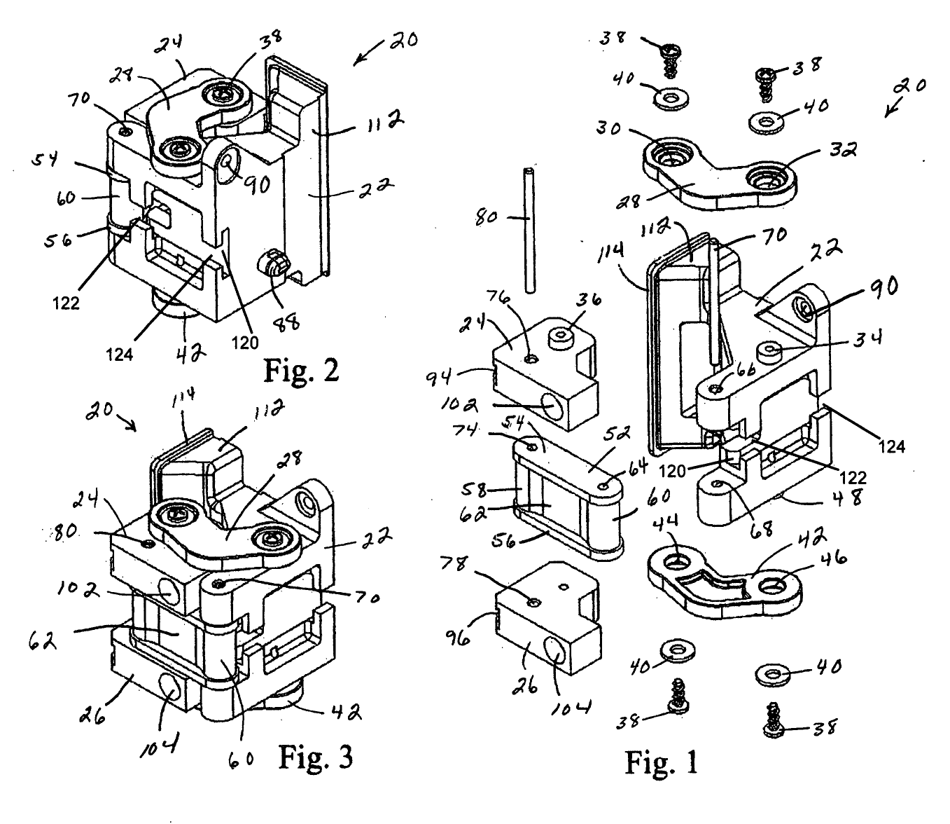

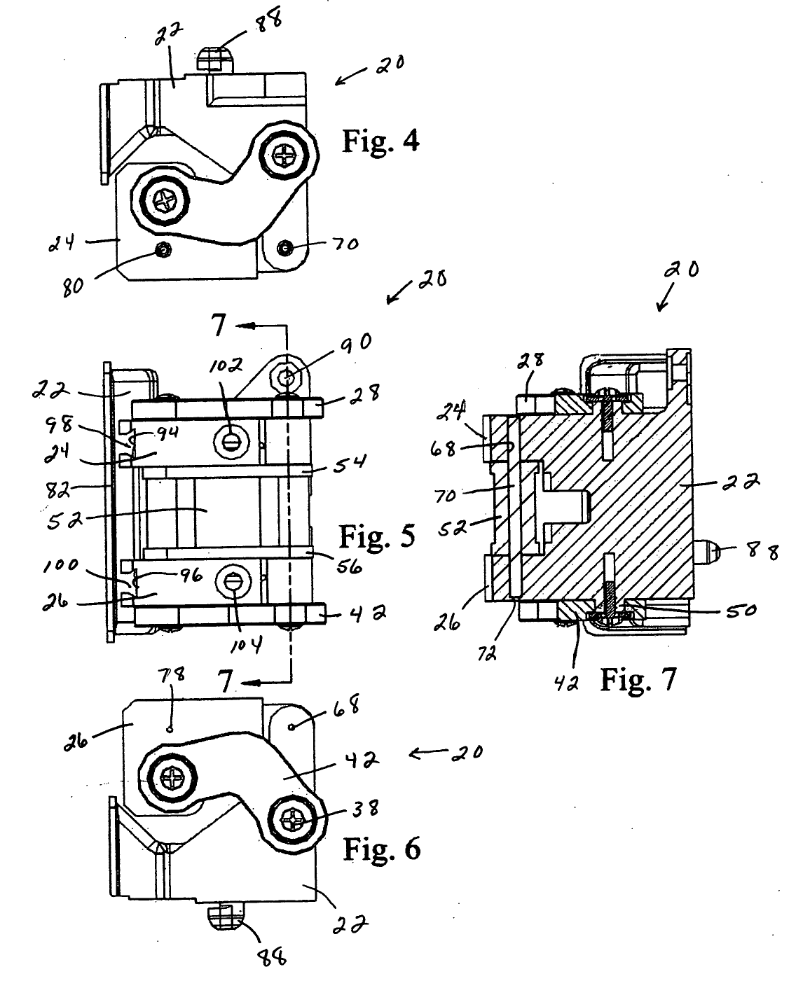

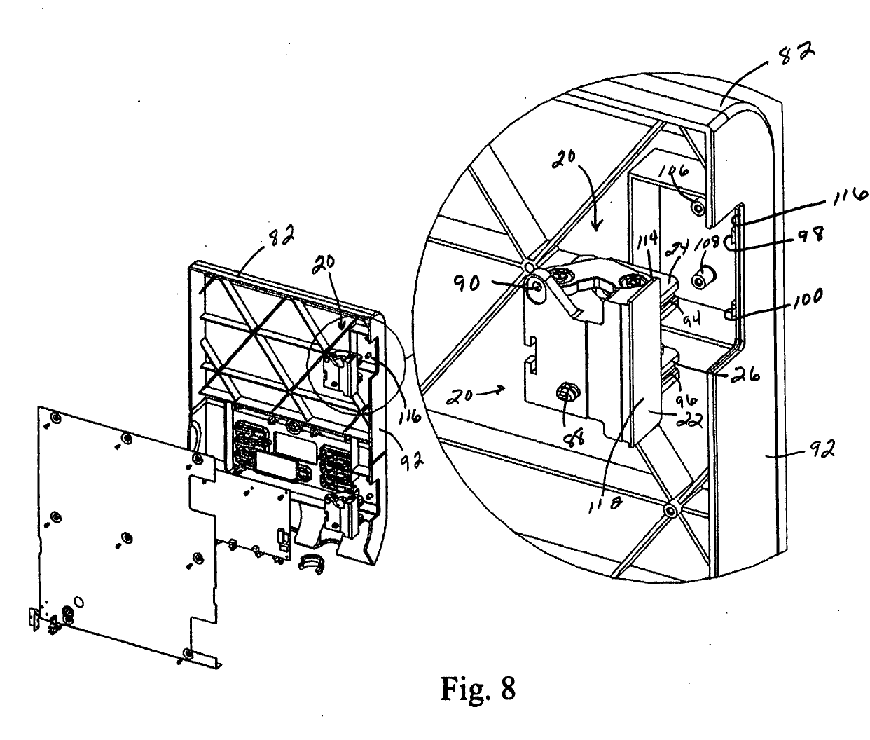

### DETAILED DESCRIPTION

There is shown in the drawings a floating hinge assembly, indicated generally at 20, structured according to the teachings of the invention. The hinge assembly includes a mounting base 22 for attachment to a cabinet or frame of a machine, usually alongside an opening or doorway in the cabinet, which machine may be a beverage dispenser, such as a soft drink or coffee dispenser. The hinge assembly also includes a door base comprising an upper door base 24 and a lower door base 26 for attachment to a door of the machine to mount the door on the cabinet, via the hinge assembly, for movement between positions over and closing the opening to the cabinet and away from and exposing the opening for access to the cabinet interior.

An angled and somewhat L-shaped upper idler arm 28 has passages 30 and 32 toward its opposite ends for rotatable attachment to each of the mounting base 22 and upper door base 24 by means of a boss 34 on an upper surface of the mounting base being received in the upper idler arm passage 32 and a boss 36 on an upper surface of the upper door base being received in the upper idler arm passage 30, with screws 38 and washers 40 rotatably attaching the upper idler arm to each of and between the mounting base and upper door base. In a similar manner, an angled and somewhat L-shaped lower idler arm 42 has passages 44 and 46 toward its opposite ends and is rotatably attached to each of the mounting base 22 and lower door base 26 by means of a boss 48 on a lower surface of the mounting base being rotatably received in the lower idler arm passage 46 and a boss 50 on a lower surface of the lower door base being rotatably received in the lower idler arm passage 44, with screws 38 and washers 40 rotatably attaching the lower idler arm to each of and between the mounting base and lower door base. The arrangement is such that the upper and lower door bases 24 and 26 are rotatable relative to their associated upper and lower idler arms 28 and 42, the upper and lower idler arms are rotatable relative to the mounting base 22, and the upper and lower door bases are thereby rotatable both about and relative to the mounting base.

Further rotatably attaching the upper and lower door bases 24 and 26 to the mounting base 22 is a pivot arm 52 that is configured to generally have parallel top and bottom plates 54 and 56, end posts 58 and 60 extending between opposite ends of the top and bottom plates, and a center wall 62. One end of the pivot arm 52 is rotatably attached to the mounting base 22 by means of aligning a passage 64 extending through the end post 60 and the plates 54 and 56 with and between a pair of passages 66 and 68 in the mounting base, and by then extending a pivot pin 70 downward through the aligned passages until a bottom end of the pivot pin rests on an annular shoulder 72 (see FIG. 7) formed in and at the lower end of the mounting base passage 68. An opposite end of the pivot arm 52 is rotatably attached to the upper and lower door bases 24 and 26 by means of aligning a passage 74 extending through the end post 58 and the plates 54 and 56 with and between a passage 76 in the upper door base 24 and a passage 78 in the lower door base 26, and by then extending a pivot pin 80 downward through the aligned passages until a bottom end of the pivot pin contacts an annular shoulder (not shown) formed in and at the lower end of the lower door base passage 78. The arrangement is such that the upper and lower door bases 24 and 26 are rotatable on and relative to the pivot arm 52, and the pivot arm is rotatable on and relative to the mounting base 22, so that the upper and lower door bases are rotatable both about and relative to the mounting base.

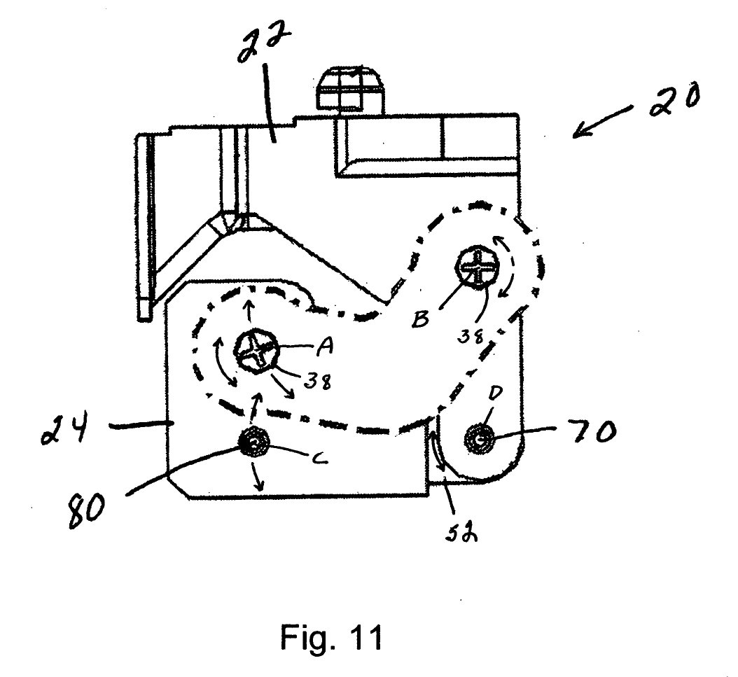

With reference also to FIG. 11, because the door bases 24 and 26 are rotatably attached to the mounting base 22 by the idler arms 28 and 42 and the pivot arm 52, as the door bases move relative to the mounting base, the door bases are constrained to move such that a longitudinal axis A of the door base bosses 36 and 50 moves in a constant radius arc about a parallel longitudinal axis B of the mounting base bosses 34 and 48 with the radius equal to the linear distance between the axes A and B, while at the same time the door bases rotate about the axis A. In addition, the door bases are also constrained to move such that a longitudinal axis C of the door base passages 76 and 78 moves in a constant radius arc about a parallel longitudinal axis D of the mounting base passages 66 and 68 with the radius equal to the linear distance between the axes C and D, while at the same time the door bases rotate about the axis C. In other words, movement of the door bases 24 and 26, when the hinge assembly 20 is used to mount a door, is constrained such that the points in the door bases through which of the axes A and C pass move in constant radius arcs about the respective points in the mounting base 22 through which the axes B and D pass.

In use of the hinge assembly 20, two or more, and usually a pair, of the hinge assemblies are used to mount a door 82 to a cabinet 84 alongside an opening 86 to an interior of the cabinet. The hinges accommodate rotation of the door between a closed position where the door is over and closes the opening to the cabinet and an open position where the door is away from and exposes the opening to accommodate access to the cabinet interior. The cabinet may be, for example, the outer housing of a beverage dispenser and the mounting base 22 of each hinge assembly 20 is attached to a front side portion 87 of the cabinet and alongside the opening 86 by first extending a hook 88 of the mounting base through an opening (not shown) in the cabinet side portion 87, then moving the hinge assembly 20 sideways to position the hook behind the front side portion, and then extending a fastener (not shown) through an opening 90 in the mounting base into threaded engagement with the cabinet side portion. To mount the door 82 for rotation relative to the cabinet 84, the upper and lower door bases 24 and 26 of each hinge assembly 20 are attached to a side panel 92 of the door by receiving within elongate grooves 94 and 96 in the respective upper and lower door bases 24 and 26 associated tongues that extend inward from the door side panel, and by receiving in openings 102 and 104 in the respective upper and lower door bases respective cylindrical extensions 106 and 108 that extend rearward from a front wall of the door.

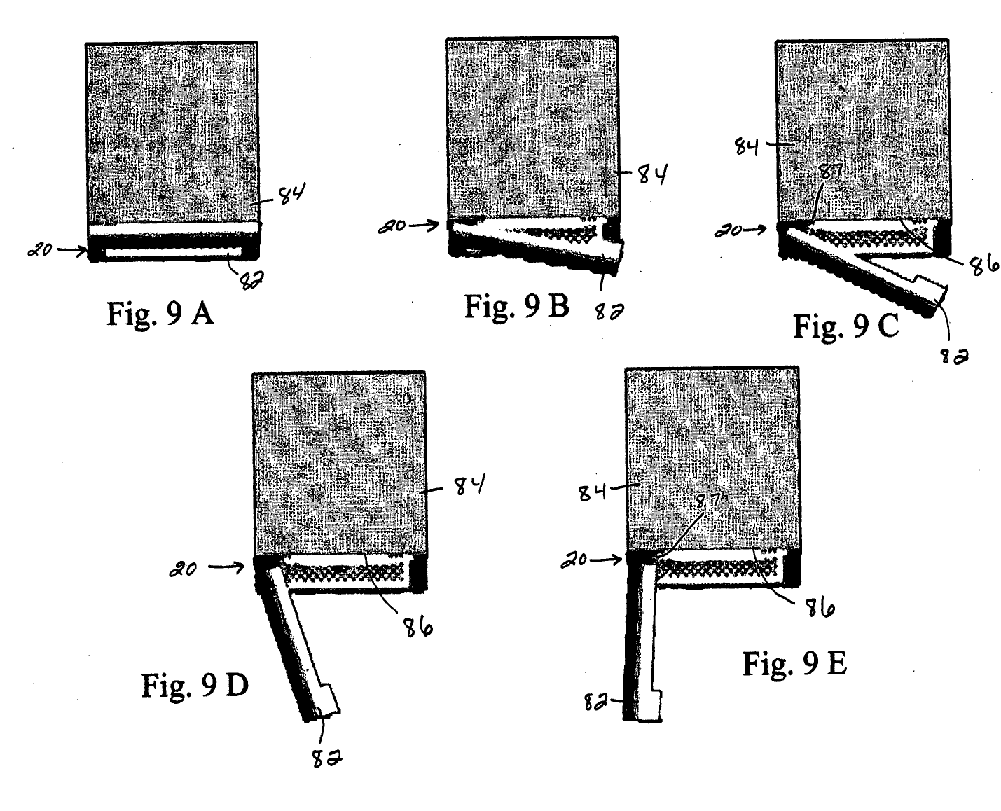

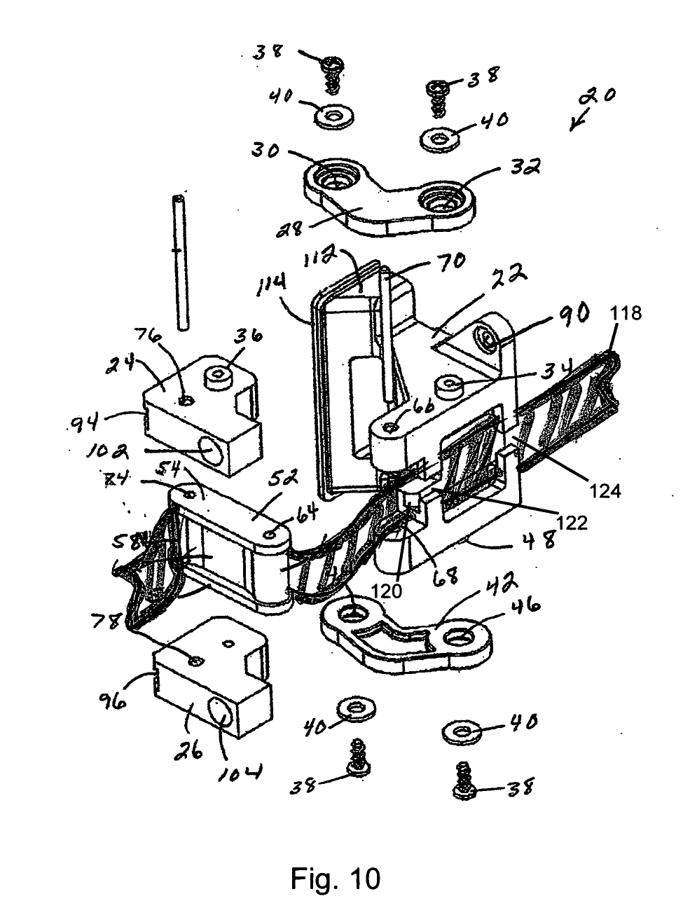

With the door 82 mounted on the cabinet 84 by the hinge assemblies 20, and with reference to FIGS. 9A-9E, as the door is opened the pivoting action of the hinge assemblies controls movement of the door, such that the left (as viewed in FIGS. 9A-9E) or hinged side of the door moves both forward away from the front of the cabinet and generally sideways relative to the cabinet front, so that the hinged side of the door never extends beyond the left side of the cabinet upon opening the door.

By virtue of the manner in which the upper and lower idler arms 28 and 42 and pivot arm 52 rotatably connect the mounting base 22 to the upper and lower door bases 24 and 26, as the door 82 is swung open the hinged end of the door is moved by the hinge assemblies 20 both forwardly outward and away from the cabinet front side portion 87 and sideways or rightward (as viewed in FIGS. 9A-9E) along the front side portion and away from the left side edge of the cabinet, by a distance about equal to a thickness of the door, so that the door does not protrude beyond the left side edge of the cabinet. The hinge assemblies provide for the pivot point of the door to be defined in a location away from the front edge of the hinged side of the door, and thereby provide for the front edge of the hinged side of the door to never move further leftward beyond, or to be more than flush with, the left side of the cabinet. The upper and lower idler arms 26 and 28 and the extension or pivot arm 52 control the travel of the door as it is opened, such that when the door is opened it pulls away from and moves generally sideways along the front of the cabinet, so that there is no interference between the door and cabinet or between the door and adjacent structures. Advantageously, the mounting base 22 includes a generally rectangular side 112 having a grooved periphery 114 on its forward, top and bottom sides that extends into an opening 116 in a side edge of the door 82 when the door is closed to seal the door seam and assist in locking the door in place.

Beverage dispensers often have a control panel on a front of a door to a cabinet of the dispenser. The control panel may be provided with user actuable switches that operate beverage valves in the cabinet interior to dispense a user selected drink. An electrical cable extends between the control panel and valves in the cabinet interior and the floating hinge assembly 20 is configured to accommodate passage of the cable between the control panel and valves.

With reference to 10, a ribbon cable 118 is shown accommodated by the floating hinge assembly 20. To permit passage of the cable through and between openings (not shown) in the door 82 and cabinet 84 that are proximate to the hinge, the hinge mounting base 22 is provided with a channel 120 that extends perpendicular to the front of the cabinet 84 and with a pair of slots 122 and 124 that open to the channel. The ribbon cable 118, which is used to electrically connect the control panel with valves and other components in the cabinet, is introduced into the channel 120 through the slots 122 and 124 and is extended around an end of the pivot arm 52, such that the cable extends from the opening in the front of the cabinet 84, through the slot 120 and around the end post 58 of the pivot arm to the opening in the door 82. Advantages of passage of the ribbon cable through the floating hinge assembly 20 include strain relief of the cable, protected of the cable from damage by the hinge assembly and, upon opening and closing of the door 82, movement of the cable is minimized and controlled to prevent damage to the cable from over-bending.

While embodiments of the invention have been described in detail, various modifications and other embodiments thereof can be devised by one skilled in the art without departing from the spirit and scope of the invention, as defined in the appended claims.

What is claimed is:

1. A floating hinge assembly, comprising:
a mounting base for attachment to a cabinet;
a door base for attachment to a door generally along a side of the door;
a pivot arm extending between and rotatably connected to each of said mounting base and said door base;
and an idler arm extending between and rotatably connected to each of said mounting base and said door base,
said pivot arm and said idler arm controlling the movement of said door base relative to said mounting base, such that when a door is mounted on a cabinet by said floating hinge assembly, as the door is moved away from the cabinet, a side of the door along which said door base is attached moves both away from and sideways relative to the cabinet.

2. A floating hinge assembly as in claim 1, comprising two door bases and two idler arms, each said idler arm extending between and rotatably connected to said mounting base and an associated one of said door bases.

3. A floating hinge assembly as in claim 3, including means on said mounting base for supporting a ribbon cable and accommodating passage of the ribbon cable past said mounting base.

4. A floating hinge assembly as in claim 2, wherein each said idler arm is elongate and rotatably attached toward one of its ends to a first point on an associated one of said door bases and toward an opposite end to a first point on said mounting base for rotation of said door bases on said idler arms about a first axis passing through said door base first points and for rotation of said idler arms on said mounting base about a second axis passing through said mounting base first points, and wherein said pivot arm is rotatably attached toward one of its ends to a second point on each of said door bases and is rotatably attached toward an opposite end to second points on said mounting base for rotation of said door bases on said pivot arm about a third axis passing through said door base second points and for rotation of said pivot arm on said mounting base about a fourth axis passing through said mounting base second points, whereby said door bases are also mounted for movement of said door base first points in an arc about said mounting base first points and for movement of said door base second points in a arc about said mounting base second points.

5. A floating hinge assembly, comprising:
a mounting base;
a door base;
first means extending between and rotatably coupled to each of said door base and said mounting base for mounting said door base for rotation about a first axis extending through a first point on said door base and for rotation about a second axis extending through a second point on said mounting base with said door base first point moving in an arc around said mounting base second point; and
second means extending between and rotatably coupled to each of said door base and said mounting base for mounting said door base for rotation about a third axis extending through a third point on said door base and for rotation about a fourth axis extending through a fourth point on said mounting base with said door base third point moving in an arc around said mounting base fourth point

6. A floating hinge assembly as in claim 5, wherein said first, second, third and fourth axes are parallel.

7. A floating hinge assembly as in claim 5, wherein said first and second mounting means constrain said door base for movement relative to said mounting base such that there is simultaneous rotation of said door base about said first and third axes and rotation of said door base first and third axes in an arc about said mounting base second and fourth axes, respectively.

8. A floating hinge assembly as in claim 5, wherein said door base comprises a pair of said door bases, said first means comprises a pair of said first means each extending between and rotatably coupled to an associated one of said door bases and said mounting base for mounting each said door base for rotation about said first axis and for rotation of said first axis in an arc around said second axis, and said second means extends between and is rotatably coupled to each of said door bases and said mounting base for mounting each said door base for rotation about said third axis and for rotation of said third axis in a arc around said fourth axis.

9. A method of hinging a door to a cabinet, comprising the steps of:
attaching a mounting base to the cabinet;
attaching a door base to a door;
rotatably coupling the door base to the mounting base for rotation of the door base about a first axis extending through a first point on the door base and about a second axis extending through a second point on the mounting base, and for rotation of the door base first axis in an arc around the mounting base second axis; and
rotatably coupling the door base to the mounting base for rotation of the door base about a third axis extending through a third point on the door base and about a fourth axis extending through a fourth point on the mounting base, and for rotation of the door base third axis in an arc around the mounting base fourth axis.

10. A method of hinging a door to a cabinet as in claim 9, wherein said rotatably coupling steps are performed such that the first, second, third and fourth axes are parallel.

11. A method of hinging a door to a cabinet as in claim 9, wherein said rotatably coupling steps are performed such that the door base is constrained for movement relative to the mounting base such that there is simultaneous rotation of the door base about the first and third axes, rotation of the first axis in an arc about the second axis and rotation of the third axis in an arc about the fourth axis.

12. A method of hinging a door to a cabinet as in claim 9, including the step of providing on the mounting base a support for a ribbon cable.
